(19) United States
(12) Patent Application Publication
(10) Pub. No.: US 2007/0052889 A1
(43) Pub. Date: Mar. 8, 2007

(54) LCOS DISPLAY PANEL

(76) Inventors: Anthony Joseph Whitehead Jr., Hsin-Chu City (TW); Ta-Shuang Kuan, Hsin-Chu Hsien (TW); Chia-Tsung Chan, Tao-Yuan Hsien (TW); Chia-Te Lin, Chia-Yi Hsien (TW)

Correspondence Address: NORTH AMERICA INTELLECTUAL PROPERTY CORPORATION, P.O. BOX 506, MERRIFIELD, VA, 22116, US

(21) Appl. No.: 10/904,154

(22) Filed: Oct. 27, 2004

(51) Int. Cl. G02F 1/1335

(52) U.S. Cl. 349/113

(57) ABSTRACT

An LCOS display panel includes a back plane, a plurality of pixel electrodes arranged in an array and positioned on the back plane, a multi-layer reflecting thin film positioned on the pixel electrodes, a front plane positioned above the multi-layer reflecting thin film, and a liquid crystal layer filled in between the multi-layer reflecting thin film and the front plane.

### BACKGROUND OF INVENTION

1. Field of the Invention

The present invention relates to an LCOS display panel, and more particularly, to an LCOS display panel which utilizes a reflecting layer having a mirror surface, instead of pixel electrodes, to reflect light beams.

2. Description of the Prior Art

LCOS (liquid crystal on silicon) display technology is the key to reflective LCD projectors and rear-projection televisions. The LCOS displays have the advantages of tiny size, high resolution, low power, low cost, etc. The difference between an LCOS display and an TFT-LCD is that the TFT-LCD uses a glass substrate or a quartz substrate as the back plane and is provided with a light source from the back side, while the LCOS display uses a silicon substrate as the back plane and is provided with a light source from the front side. As a result, the manufacturing of LCOS display panels can be integrated into standard semiconductor processes, and therefore has high stability and resolution.

Please refer to FIG. 1, which is a schematic diagram of a conventional LCOS display panel 10. As shown in FIG. 1, the LCOS display panel 10 includes a back plane 12, a plurality of pixel electrodes arranged in an array and positioned on the surface of the back plane 12, a front plane 16 positioned in parallel and above the back plane 12, a liquid crystal layer 18 interposed between the back plane 12 and the front plane 16, and a transparent electrode layer 20 positioned on the surface of the front plane 16 facing the back plane 12. In addition, the LCOS display panel 10 further includes a top alignment layer on the surface of the transparent electrode layer 20, and a bottom alignment layer 24 positioned on the surface of the pixel electrodes 14 for controlling the arrangement direction of the liquid crystal molecules in the liquid crystal layer 18. The back plane 12 is a silicon substrate, and includes a plurality of MOS elements for respectively driving each pixel electrode 14. The front plane 16 is a transparent substrate, such as a glass substrate or a quartz substrate. The pixel electrodes 14 are made of conductive materials, such as aluminum, and must have a mirror surface for reflecting lights.

An LCOS display substantially includes an optical engine and an LCOS display panel, and LCOS displays can be classified into three-panel type LCOS displays and single-panel type LCOS displays. The optical engine used in the three-panel type LCOS display must be incorporated with color separation and color combination functions so as to divide the light source into a red light beam, a green light beam, and a blue light beam, project different light beams to three different LCOS display panels, and combine different light beams reflecting from different LCOS display panels to form a colorful image.

On the other hand, the single-panel type LCOS display becomes more popular since only one single panel is used. The single-panel type LCOS displays are classified into color wheel type LCOS displays and color filter type LCOS displays. The color wheel type LCOS display utilizes a color wheel system to separate a white light source into a red light beam, a green light beam, and a blue light beam, and projects different light beams to the LCOS display panel sequentially in a short period of time. By taking account of the vision persistence characteristic of human eyes, the viewer therefore sees a color image. The color filter type LCOS display includes a plurality of color filters positioned on the front plane, as an LCD display does, so as to form a color projection image.

The pixel electrodes 14 of the conventional LCOS display panel 10 must have a mirror surface to reflect light beams, therefore the shape of the pixel electrodes 14 cannot be adjusted to improve the discharging efficiency. However, this limitation makes the design of the pixel electrodes 14 less flexible. For example, the fringe field effect, which is undesired, frequently occurs in the edge of the pixel electrodes 14 having a mirror surface. If the shape of the pixel electrodes 14 can be redesigned (e.g. a rounding shape), the fringe field effect will be reduced and the display effect will be improved.

### SUMMARY OF INVENTION

It is therefore a primary objective of the present invention to provide an LCOS display panel for solving the aforementioned problem.

According to a preferred embodiment of the present invention, an LCOS display panel is provided. The LCOS display panel includes a back plane, a plurality of pixel electrodes arranged in an array and positioned on the back plane, a reflecting layer positioned on a surface of the pixel electrodes, a front plane positioned above the reflecting layer, and a liquid crystal layer filled in between the reflecting layer and the front plane.

These and other objectives of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a schematic diagram of a conventional LCOS display panel.

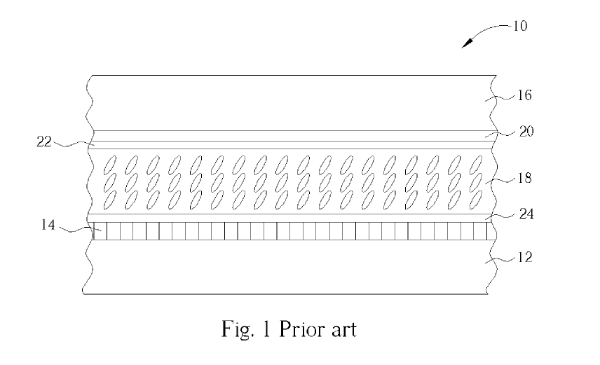

FIG. 2 is a schematic diagram of an LCOS display panel according to a preferred embodiment of the present invention.

### DETAILED DESCRIPTION

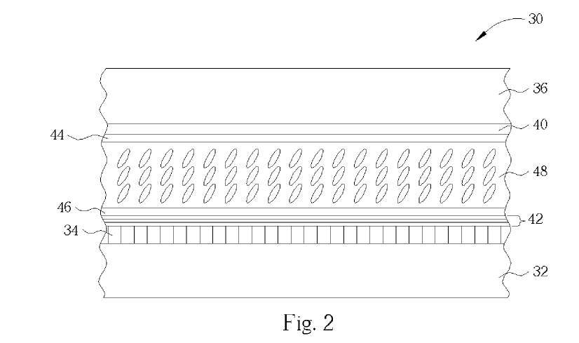

Please refer to FIG. 2, which is a schematic diagram of an LCOS display panel 30 according to a preferred embodiment of the present invention. As shown in FIG. 2, the LCOS display panel 30 includes a back plane 32, a plurality of pixel electrodes 34 arranged in an array and positioned on the surface of the back plane 32, a front plane 36, a liquid crystal layer 38 interposed in between the back plane 32 and the front plane 34, and a transparent electrode layer 40 positioned on the surface of the front plane 36 facing the back plane 32. The LCOS display panel 30 further includes a reflecting layer 42 positioned on the surface of the pixel electrodes 34, a top alignment layer 44 positioned on the surface of the transparent electrode layer 40, and a bottom alignment layer 46 positioned on the surface of the reflecting layer 42.

The back plane 32 is a semiconductor substrate (such as a silicon substrate) including a plurality of MOS elements (not shown) fabricated by standard semiconductor processes, and each MOS element (not shown) is electrically connected to a corresponding pixel electrode 34 for controlling the pixel electrodes 34. The pixel electrodes 34 are made of conductive materials, such as aluminum or titanium nitride, for providing excellent electrical performance. The front plane 36 is a transparent substrate such as a glass substrate or a quartz substrate. The transparent electrode layer 40 is composed of transparent conductive materials, such as indium tin oxide (ITO), for providing a common voltage. The common voltage and the driving voltage provided by the pixel electrodes 34 generates different voltage differences in different pixel regions so as to drive the liquid crystal molecules in the liquid crystal layer 38 to rotate. The top alignment layer 44 and the bottom alignment layer 46 make the liquid crystal molecules rotate in predetermined directions so as to accurately control the amount of penetrating light beams.

It is noted that the pixel electrodes 34 of the LCOS display panel 30 only serve as electrodes, while the reflection effect is accomplished by the reflecting layer 42 positioned on the surface of the pixel electrodes 34. In this embodiment, the reflecting layer 42 is composed of a plurality of insulating photo thin films, such as silicon oxide, titanium oxide, tantalum oxide, etc., and formed by various thin film technologies, such as PVD, CVD, planarization processes, etc., and thus has a mirror surface. In addition, the reflection effect can be improved by adjusting different parameters, such as modifying the compositions, refractivity, and thickness of each optical thin film. Furthermore, the reflecting layer 42 can also be composed of a high reflective insulating material. Experimental results have proved that the reflecting layer 42 made of optical thin films has a high reflectivity more than 98%. On the contrary, the reflectivity of the pixel electrode (e.g. aluminum electrode) only reaches to 92%.

It is also to be noted that in the above embodiment the LCOS display panel 30 is applied to a three-panel type LCOS display or a color wheel type LCOS display, and thus color filters are not installed. However, the application of the LCOS display panel 30 is not limited to the above embodiment, and can be applied to a color filter type LCOS display as long as color filters are installed.

In comparison with the prior art, the LCOS display panel 30 utilizes the reflecting layer 42, instead of the pixel electrodes 34, to reflect light beams, and has a better reflection effect. On the other hand, the pixel electrodes 34 only serve as electrodes, therefore the shape or structure of the pixel electrodes 34 can be redesigned to exhibit better discharge effects. For example, a corner rounding process can be performed or a non-planar structure can be formed by over etching when forming the pixel electrodes 34, so as to reduce the fringe field effect.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An LCOS display panel comprising:
a back plane;
a plurality of pixel electrodes, arranged in an array, positioned on the back plane;
a reflecting layer positioned on a surface of the pixel electrodes;
a front plane positioned above the reflecting layer; and
a liquid crystal layer filled in between the reflecting layer and the front plane.

2. The LCOS display panel of claim 1, wherein the reflecting layer comprises a plurality of optical thin films with different refractivities.

3. The LCOS display panel of claim 1, wherein the reflecting layer is insulating.

4. The LCOS display panel of claim 1, further comprising a transparent electrode layer positioned between the front plane and the liquid crystal layer.

5. The LCOS display panel of claim 4, further comprising a top alignment layer positioned between the transparent electrode layer and the liquid crystal layer, and a bottom alignment layer positioned between the reflecting layer and the liquid crystal layer.

6. The LCOS display panel of claim 1, wherein the reflecting layer has a mirror surface for reflecting light beams.

7. An LCOS display panel comprising:
a back plane;
a plurality of pixel electrodes, arranged in an array, positioned on the back plane;
a multi-layer reflecting thin film positioned on a surface of the pixel electrodes;
a front plane positioned above the multi-layer reflecting thin film; and
a liquid crystal layer filled in between the multi-layer reflecting thin film and the front plane.

8. The LCOS display panel of claim 7, wherein each layer of the multi-layer reflecting thin film has a different refractivity.

9. The LCOS display panel of claim 7, wherein the multi-layer reflecting thin film is insulating.

10. The LCOS display panel of claim 7, further comprising a transparent electrode layer positioned between the front plane and the liquid crystal layer.

11. The LCOS display panel of claim 10, further comprising a top alignment layer positioned between the transparent electrode layer and the liquid crystal layer, and a bottom alignment layer positioned between the multi-layer reflecting thin film and the liquid crystal layer.
